(19) United States
(12) Patent Application Publication
(10) Pub. No.: US 2021/0150631 A1
(43) Pub. Date: May 20, 2021

(54) MACHINE LEARNING APPROACH TO AUTOMATICALLY DISAMBIGUATE AMBIGUOUS ELECTRONIC TRANSACTION LABELS

(71) Applicant: Intuit Inc., Mountain View, CA (US)

(72) Inventors: Yehezkel Shraga Resheff, Jerusalem (IL); Yair Horesh, Kfar Sava (IL); Noa Haas, Hod HaSharon (IL); Liron Hayman, Hod HaSharon (IL)

(73) Assignee: Intuit Inc., Mountain View, CA (US)

(21) Appl. No.: 16/688,836

(22) Filed: Nov. 19, 2019

(51) Int. Cl. G06Q 40/00; G06N 3/08; G06N 3/04; G06Q 40/02

(52) U.S. Cl. CPC G06Q 40/12; G06Q 40/02; G06N 3/0445; G06N 3/08

(57) ABSTRACT

A method including establishing, using electronic transactions of a user, a geo-temporal trajectory of the user. The method also includes forming a first data structure by sub-dividing the geo-temporal trajectory into segments including subsets of the electronic transactions along the geo-temporal trajectory. Sub-dividing is performed with respect to a selected feature. The method also includes gathering, for a subset of the segments, a corresponding labeled dataset of transactions within the electronic transactions to generate a second data structure. The method also includes applying, as input, the second data structure to a machine learning classifier. The method also includes receiving, from the machine learning classifier, an assignment of disambiguated labels to the electronic transactions. The method also includes storing, automatically in a financial management application, the disambiguated labels as assigned to the electronic transactions.

### BACKGROUND

Automatically classifying electronic transactions is difficult. The same event could potentially have different meanings depending on a wider context. Thus, even with artificial intelligence systems, ambiguous electronic transactions may be incorrectly categorized during automatic classification.

### SUMMARY

In general, in one aspect, one or more embodiments relate to a method. The method includes establishing, using electronic transactions of a user, a geo-temporal trajectory of the user. The method also includes forming a first data structure by sub-dividing the geo-temporal trajectory into segments including subsets of the electronic transactions along the geo-temporal trajectory. Sub-dividing is performed with respect to a selected feature. The method also includes gathering, for a subset of the segments, a corresponding labeled dataset of transactions within the electronic transactions to generate a second data structure. The method also includes applying, as input, the second data structure to a machine learning classifier. The method also includes receiving, from the machine learning classifier, an assignment of disambiguated labels to the electronic transactions. The method also includes storing, automatically in a financial management application, the disambiguated labels as assigned to the electronic transactions.

The one or more embodiments also relate to a system. The system includes a data repository. The data repository stores electronic transactions of a user. The data repository also stores a training dataset including pre-labeled prior electronic transactions. The data repository also stores a geo-temporal trajectory of the user. The data repository also stores a first data structure including the geo-temporal trajectory divided into segments including a subsets of the electronic transactions along the geo-temporal trajectory. The geo-temporal trajectory is divided with respect to a selected feature. The data repository also stores a second data structure including a labeled dataset of transactions within the transactions. The labeled dataset is for a subset of the segments. The data repository also stores disambiguated labels assigned to the electronic transactions. The system also includes a machine learning classifier. The machine learning classifier is trained using the training dataset. The machine learning classifier is also trained to determine how the geo-temporal trajectory influences labeling of the electronic transactions. The machine learning classifier is also trained to classify the electronic transactions by receiving, as input, the second data structure and by outputting the disambiguated labels applicable to the electronic transactions. The system also includes a financial management application (FMA) programmed to: manage finances of a user, and apply the disambiguated labels to the electronic transactions to generate a third data structure.

The one or more embodiments also relate to a non-transitory computer readable storage medium storing program code which, when executed by a processor, performs a computer-implemented method. The computer-implemented method includes establishing, using electronic transactions of a user, a geo-temporal trajectory of the user. The computer implemented method also includes forming a first data structure by sub-dividing the geo-temporal trajectory into segments including subsets of the electronic transactions along the geo-temporal trajectory. Sub-dividing is performed with respect to a selected feature. The computer implemented method also includes gathering, for a subset of the segments, a corresponding labeled dataset of transactions within the electronic transactions to generate a second data structure. The computer implemented method also includes applying, as input, the second data structure to a machine learning classifier. The computer implemented method also includes receiving, from the machine learning classifier, an assignment of disambiguated labels to the electronic transactions. The computer implemented method also includes storing, automatically in a financial management application, the disambiguated labels as assigned to the electronic transactions.

Other aspects of the invention will be apparent from the following description and the appended claims.

### BRIEF DESCRIPTION OF DRAWINGS

FIG. 1 and FIG. 2 illustrate automatic labeling of electronic transactions, in accordance with one or more embodiments.

FIG. 3 illustrates a system for automatic labeling of electronic transactions, in accordance with one or more embodiments.

FIG. 4A illustrates a method for automatic labeling of electronic transactions, in accordance with one or more embodiments.

FIG. 4B shows a method for performing subdivision of a trajectory, in accordance with one or more embodiments.

FIG. 5, FIG. 6, and FIG. 7 illustrate examples of data structures, in accordance with one or more embodiments.

FIG. 8 illustrates a specific example of automatic disambiguous labeling of electronic transactions, in accordance with one or more embodiments.

FIGS. 9A and 9B depicts a computer system and network in accordance with one or more embodiments

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to a machine learning approach to automatically disambiguate ambiguous electronic transaction labels. The one or more embodiments address the technical issue of how to use a machine learning model to automatically disambiguate ambiguous electronic transaction labels, in part, by identifying and sub-dividing a geo-temporal trajectory of a user. A geo-temporal trajectory is data that represents the locations of a user along a physical path in space, times at which the user is at the locations, or a combination thereof. Information gleaned from the geo-temporal trajectory are used by a trained machine learning model to disambiguate between multiple labels that, considered alone without the geo-temporal trajectory, could have been applied automatically to a single electronic transaction. Thus, the one or more embodiments are directed to configuring a computing system to learn a transaction's purpose using trajectory segmentation and labeling.

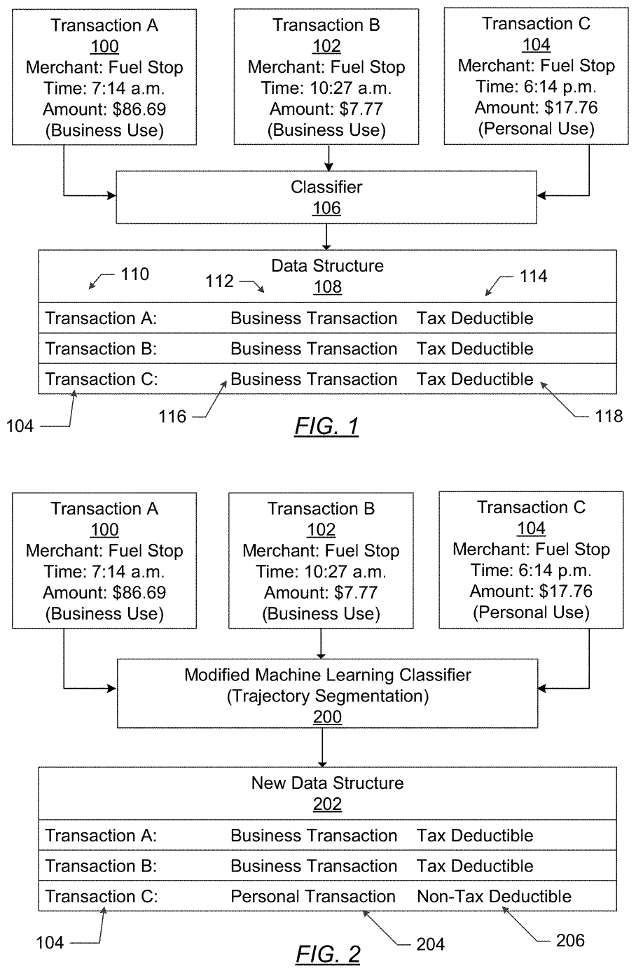

FIG. 1 and FIG. 2 illustrate automatic labeling of electronic transactions, in accordance with one or more embodiments. FIG. 1 is an example which serves to identify a technical issue encountered when using machine learning classification to automatically label electronic transactions. FIG. 2 is an example of an overview of a technical approach to addressing the technical issue described with respect to FIG. 1. Note that for both FIG. 1 and FIG. 2, many more transactions and data structures may be present, and the data structures may be more complex in real enterprise systems. However, for the sake of clarity, the number of transactions and the data structures have been reduced and simplified in FIG. 1 and FIG. 2.

The example of FIG. 1 assumes that a single user has performed three electronic transactions in a day at different times: Transaction A (100), Transaction B (102), and Transaction C (104). All three transactions are performed at a merchant named “Fuel Stop.” In each case, the user purchased fuel. Transaction A (100) is for $86.89, Transaction B (102) is for $7.77, and Transaction C (104) is for $17.76.

Each transaction is automatically recorded by an electronic financial management application (FMA). In turn, the classifier (106) interacts with the financial management application in order to automatically apply an electronic label to each transaction. Specifically, the classifier (106) is designed to receive data regarding the transactions and assign the label to be applied to each transaction.

However, a technical issue arises because Transaction A (100), Transaction B (102), and Transaction C (104) are ambiguously labeled. In each case, the transaction could have been labeled “business” or “personal.” The proper automatic labeling may be important for tax preparation reasons; however, the classifier is unable to automatically produce the desired disambiguated output of a disambiguated label.

Based on the history of use, and possibly on prior user-designated labels for prior electronic transactions at Fuel Stop, the classifier (106) identifies the labels to be applied to Transaction A (100), Transaction B (102), and Transaction C (104). In this example, the output of the classifier (106) is a data structure (108) which includes a transaction identifier (110), a label (112) for each transaction identifier (110), and a meaning (114) of the label (112). Given that past user labels most frequently applied the “business transaction” label to transactions at Fuel Stop, the classifier (106) outputs a highest probability likelihood that all three transactions are “business transactions.”

However, for Transaction C (104), the specific label (116) assigned by the classifier (106) is incorrect. As indicated above, Transaction C (104) is a personal transaction. The error carries an error in meaning, as the specific meaning (118) for Transaction C (104) is now “tax deductible.” As a result, the error may propagate to other electronic programs, such as tax preparation programs.

For example, the specific meaning (118) in the data structure (108) may be applied automatically as a label (112) for the transaction in the tax preparation application or in a financial management application. As a result, while the tax preparation or financial management application may behave correctly, because the underlying label (112) is incorrect, the output of the tax preparation or financial management application may be incorrect. This result may be undesirable.

Thus, a technical issue is presented: How to program or train the classifier (106) to disambiguate labels when automatically assigning labels to electronic transactions, when multiple ambiguous labels could be applied and the data available in the transactions is insufficient to perform disambiguation. Again, prior labeling by the user, even in combination with the transaction information, is also insufficient information for the classifier (106) to be trained to disambiguate the labels.

Attention is now turned to FIG. 2, which illustrates an overview of a technical technique for addressing the technical issue identified above. Note that reference numerals in FIG. 2 in common with reference numerals used in FIG. 2 refer to the same objects and have the same descriptions.

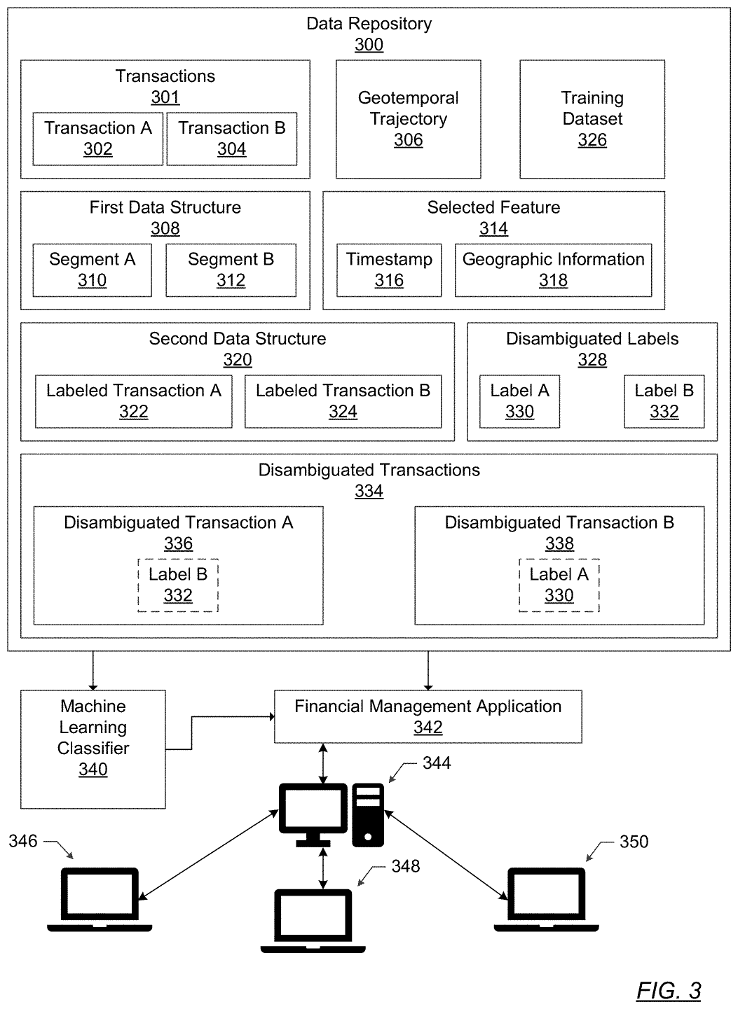

The example of FIG. 2 assumes the same user performs the same three electronic transactions, each having the same three intended labels. However, the one or more embodiments provide for a modified machine learning classifier (200) which disambiguates the labels and automatically applies the user-intended labels through the use of improved data structures described with respect to FIG. 3 through FIG. 8.

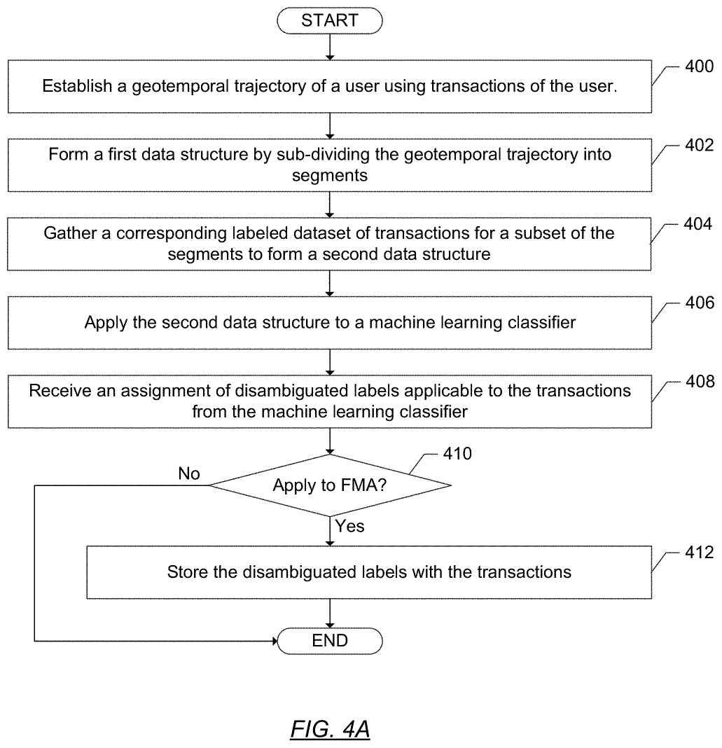

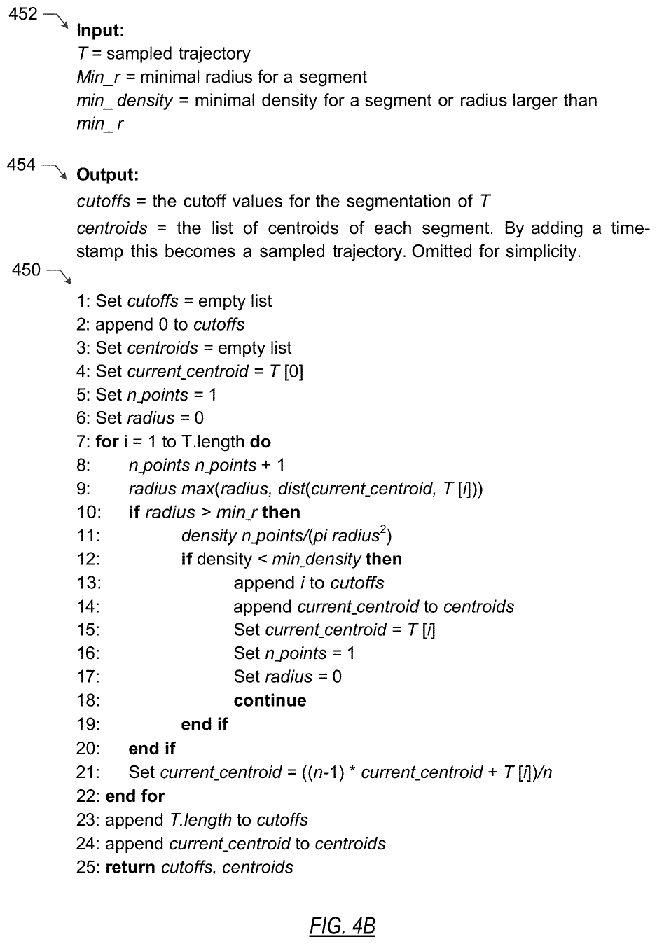

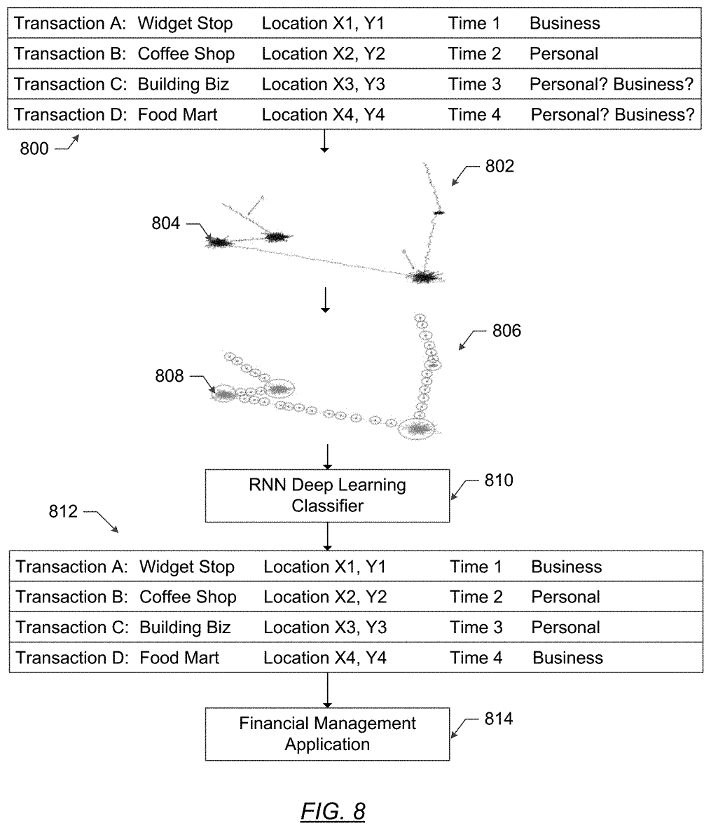

In particular, the modified machine learning classifier (200) is trained with additional information presented in the form of an improved data structure. The additional information is taken from a geo-temporal trajectory of the user. Again, a geo-temporal trajectory is data that represents the locations of a user along a physical path in space, times at which the user is at the locations, or a combination thereof. The data structure that represents the geo-temporal trajectory is a segmented representation of the user's travels in time and/or space. An example of a geo-temporal trajectory is shown in FIG. 8. Use of the geo-temporal trajectory is described with respect to FIG. 4A. The improved data structures are described with respect to FIG. 3 and FIG. 5 through FIG. 8.

As a result of the improved data structures used as input to the modified machine learning classifier (200), the output is of the machine learning classifier (200) is more accurate. The output is new data structure (202). In this example, Transaction C (104) has a revised label (204) with a revised specific meaning (206). Specifically, the revised label (204) of Transaction C (104) is “personal transaction,” which carries the revised specific meaning (206) of “non-tax deductible.” As a result, subsequent programs (not shown), such as a tax preparation or financial management application, will have the correct underlying data when managing the user's finances or preparing the user's tax returns.

FIG. 3 illustrates a system for automatic labeling of electronic transactions, in accordance with one or more embodiments. The system shown in FIG. 3 may be used to form the improved data structures and the modified machine learning classifier (200) described with respect to FIG. 2.

In one or more embodiments of the invention, the data repository (300) is any type of storage unit and/or device (e.g., a file system, database, collection of tables, or any other storage mechanism) for storing data. Further, the data repository (300) may include multiple different storage units and/or devices. The multiple different storage units and/or devices may or may not be of the same type or located at the same physical site.

The data repository (300) stores transactions (301) of a user, such as Transaction A (302) and Transaction B (304). As used herein, the terms “transaction” or “transactions” refer to electronic transaction(s). An electronic transaction is data in an electronic format that is processable by a computer and that relates to a financial transaction. The electronic transaction may not be human readable, unless rendered by a computer on a graphical user interface. Unless stated explicitly otherwise, a “transaction” is an electronic transaction and does not relate to non-computerized transactions.

The transactions (301) are “of a user,” meaning that a user has taken some action which resulted in the transactions (301) being generated or that an action is performed on behalf of the user. For example, a user may use a credit card at a merchant point of sale device, which results in the creation of the Transaction A (302). For this reason, the Transaction A (302) is associated with that user.

Nevertheless, the one or more embodiments contemplate that additional transactions (301) may be present for additional users. Thus, while the example of FIG. 3 may be described with respect to one user, the one or more embodiments contemplate similar techniques being used with respect to many different users. Therefore, Transaction A (302) and Transaction B (304) may be considered representative of transactions (301) by multiple users.

Each of the transactions (301) may be considered a separate corresponding data structure. For example, a transaction may be received from a financial institution or a point of sale device as a delimited file, a text file, an HTML (hypertext transfer markup language) file, or some other data structure. The data structure of the transaction may include one or more data entries, such as but not limited to a time of the transaction and a location of the transaction.

The data repository (300) also stores a geo-temporal trajectory (306) of the user. Again, the geo-temporal trajectory (306) is data that represents the locations of a user along a physical path in space, times at which the user is at the locations, or a combination thereof. As with the transactions (301), multiple geo-temporal trajectories may be stored in the data repository (300), at least one per user. Additionally, multiple geo-temporal trajectories may be stored for a single user.

An example of a geo-temporal trajectory (306) is shown in FIG. 8. A process for creating the geo-temporal trajectory (306) is described with respect to FIG. 3.

Mathematically, the geo-temporal trajectory (306) may be defined as a trajectory, T, which is a continuous mapping from a time interval to positions according to expression (1):

T:[a,b]→R^{k} (1)

In expression (1), T(t) is the position at time tϵ[a, b], “a” and “b” are positions in space, and R is the set of transactions (301). For three physical dimensions, kϵ{2, 3}.

A sampled trajectory is a set of time and position tuples given by expression 2:

{(tᵢ,pᵢ)}i₁ⁿ (2)

In expression (2), for some trajectory T, and some set of timestamps tϵ[a, b], p=T(t), “t” is a time, “p” is a position, “i” represents a particular transaction, and “n” represents the last transaction in a series of transactions.

The data repository (300) also stores a first data structure (308). The first data structure (308) may be the geo-temporal trajectory (306) divided into segments, such as Segment A (310) and Segment B (312). More or fewer segments may be present. A segment is defined as a contiguous subset of the transactions (301) along the geo-temporal trajectory (306). Thus, for example, the Transaction A (302) may be in the Segment A (310). Each segment may include multiple specific transactions. Thus, both the Transaction A (302) and the Transaction B (304) may be in the Segment A (310).

The first data structure (308) may contain a variety of different information. For example, the first data structure (308) may include, for each transaction in the corresponding segment, a user identifier, a segment identifier, a time, a position, a number of transactions within a segment, combinations thereof, and possibly additional types of information.

The geo-temporal trajectory (306) is divided with respect to a selected feature (314). The selected feature (314) may be time, space, and a combination of time and space.

The time may be recorded by a timestamp (316) of a particular transaction. The time could be recorded from a different source, such as from a mobile device of the user.

The space may be defined by geographic information (318) stated or implied in a specific transaction. A stated space location may be an address. An implied location may be a merchant identify, for which a location may be looked-up. In an embodiment, all information for the selected feature may be taken from the transaction itself, such as a known address associated with a merchant or other provider at which the transaction took place, geographic information specified in the transaction itself, etc. The geographic information (318) could also take the form of global positioning system (GIS) information of the user (such as from a mobile phone). Thus, in other embodiments, additional geo-temporal information related to the user may be gleaned from sources other than the transactions themselves.

The data repository (300) may also store a second data structure (320). The second data structure (320) may be a labeled dataset of transactions within the transactions (301). The labeled dataset of transactions may be, for example, Labeled Transaction A (322) and Labeled Transaction B (324). The labeled dataset of transactions may be taken from among the transactions (301) described above. However, the labeled dataset of transactions have already been labeled, such as manually by the user, or otherwise may have been verified as having a correct label. Each corresponding labeled dataset may occur within a particular segment of the segments of the first data structure (308).

The second data structure (320) may contain a variety of specific information. For example, the second data structure (320) may contain, for each transaction in a particular segment, a user identifier that uniquely identifies the user, a transaction identifier that uniquely identifies a particular financial transaction, a segment identifier that uniquely identifies a segment to which the financial transaction is assigned, a merchant identifier that uniquely identifies the merchant, an amount of the transaction, a description of the transaction, combinations thereof, and possibly other information.

The labeled dataset may be for a subset of the segments. For example, either one of Labeled Transaction A (322) or Labeled Transaction B (324), may be designated as belonging to Segment B (312). For this reason, the second data structure (320) may be a revision of the first data structure (308). However, any of the labeled dataset of transactions could be taken from pre-labeled transactions provided by the user, such as past transactions from past times or locations along the geo-temporal trajectory (306) or possibly from a similar, but different geo-temporal trajectory. In any case, the second data structure (320) contains labeled transactions having labels that are known or assumed to be correct.

The data repository (300) also may store a training dataset (326). A training dataset is data that is used in the process of training a machine learning model, as described with respect to FIG. 4A. The training dataset (326) may be pre-labeled prior transactions. A pre-labeled prior transaction is a transaction that has been previously labeled by the user or verified to have been correct by a user. Thus, pre-labeled prior transactions have labels that have been previously disambiguated in some manner by the user. The training dataset (326) thus allows a machine learning model to identify patterns in user behavior over a trajectory. In this manner, the machine learning model, when executed, can predict that a transaction performed at time X at merchant Y is more likely to be properly labeled as “personal” versus “business,” for example.

The data repository (300) also stores disambiguated labels (328), such as Label A (330) and Label B (332). A disambiguated label is a label selected by machine learning from among multiple labels that could have been assigned to a transaction based solely on the information in a single transaction itself. Stated differently, the term “ambiguous” means that at least one the transactions (301) has multiple, mutually exclusive labels applicable to at least one of the transactions (301). From the example of FIG. 2, the Transaction C (104) has a disambiguated label of “personal transaction” selected by the modified machine learning classifier (200). Note that, looking solely at the information at Transaction C (104), the label for the Transaction C (104) could also have been “business transaction.”

The disambiguated labels (328) are applicable to the transactions (301), such as Transaction A (302) and Transaction B (304). In a specific example, Label A (330) may be applied to Transaction B (304).

The data repository (300) may also store information in the form of disambiguated transactions (334). A disambiguated transaction is a transaction to which a disambiguated label has been applied. Thus, for example, disambiguated transaction A (336) may be Transaction A (302) to which Label B (332) has been applied. Similarly, disambiguated transaction B (338) may be Transaction B (304) to which Label A (330) has been applied.

Note that these labels could have been switched in some other example. Note also that Label A (330) and Label B (332) are shown in phantom lines within the disambiguated transactions (334) to show that the reproduction of the labels within the disambiguated transactions (334) is for clarity and not necessarily a duplication of information within the data repository (300).

The system shown in FIG. 3 may also include a machine learning classifier (340). Most generally, the machine learning classifier (340), otherwise known as a machine learning model, is an algorithm and/or statistical model that computer systems may use to perform a specific task without using explicit instructions, relying on patterns and inference instead of the explicit instructions or rules. Machine learning algorithms build a mathematical model based on sample data, known as “training data”, in order to make predictions or decisions without being explicitly programmed to perform the task.

The machine learning classifier (340) may be a variety of different classifiers. For example, the machine learning classifier (340) may be a deep learning classifier, a recurrent neural network, or some other type of machine learning model.

In the system of FIG. 3, the machine learning classifier (340) is trained using the training dataset (326). In particular, the machine learning classifier (340) is trained to determine or predict how the geo-temporal trajectory (306) influences labeling of the transactions (301).

Training and use of the machine learning classifier (340) are described further with respect to FIG. 4A. However, in summary, the machine learning classifier (340) may be trained to classify the transactions (301) by receiving, as input, the second data structure (320) and by outputting the disambiguated labels (328) applicable to the transactions (301).

The system shown in FIG. 3 also may include financial management application (342). The financial management application (342) may be configured to manage the finances of the user, to prepare the taxes of the user, or a combination thereof. In an embodiment, the term “manage the finances of the user” may also contemplate preparation of tax forms for the individual. The financial management application (342) may take the form of a cloud-based service accessible via a Web browser. The financial management application (342) may also take the form of a stand-alone program which is downloaded or otherwise installed on a local computer of the user.

The financial management application (342) may apply the disambiguated transactions (334) to the transactions (301). The application of the disambiguated transactions (334) in this manner may result in a third data structure, such as the disambiguated transactions (334).

The system shown in FIG. 3 may also include a server (344) which executes the financial management application (342) and/or the machine learning classifier (340). The server (344) may be in communication with many different computers.

For example, the server (344) may be in communication with a point of sale device (346). The point of sale device (346) is hardware and/or software which may generate one or more of the transactions (301).

The server (344) may also be in communication with a financial institution computer (348). The financial institution computer (348) may be a computer belonging to a bank or some other financial institution. The financial management application (342) may use data from the financial institution computer (348) and may possibly take the transactions (301) from the financial institution computer (348).

The server (344) may also be in communication with a user computer (350). The user computer (350) may also be a source of the transactions (301). The user computer (350) may also present a graphical user interface with which the user interacts with the financial management application (342).

While FIG. 3 shows a configuration of components, other configurations may be used without departing from the scope of the invention. For example, various components may be combined to create a single component. As another example, the functionality performed by a single component may be performed by two or more components.

FIG. 4A illustrates a method for automatic labeling of electronic transactions, in accordance with one or more embodiments. The method shown in FIG. 4A may be performed using the system shown in FIG. 2 or the system shown in FIG. 3. The steps described with respect to FIG. 4A may also be executed by a computer, such as any of the computers or nodes described with respect to FIG. 10.

At step 400, a geo-temporal trajectory of a user may be established using transactions of the user. In particular, the mathematical definition of a trajectory presented with respect to FIG. 3 may be used, taking the transactions as input, to generate the trajectory of the user. Generating the trajectory may be performed by ordering the transactions according to a timestamp within the transactions (e.g., the time representing when the transaction was performed). Temporally consecutive transactions in the order are connected using a connection (e.g., a stored reference between the connected transactions). The geographical location is obtained from the transaction and is used to relate each transaction to a location on a map. When the transaction is related to a location on a map, the connection based on being temporally consecutive is maintained. In one or more embodiments, the combination of the connections between transactions and the geographical locations of the transactions form the geo-temporal trajectory.

The exact parameters for establishing a new geo-temporal trajectory may be varied based on a variety of factors. The new geo-temporal trajectory may be different from other geo-temporal trajectories for the same user. The breaks in transactions separating the geo-temporal trajectories may be based on various factors. The factors include, but are not limited to expected time durations between transactions (e.g., the frequency of transactions during a given time period), the density of merchants in an area (e.g. the number of possible transaction points within a densely populated city versus a rule area), expected user behavior (e.g., a break may be expected overnight during sleeping periods, or perhaps over a period of a week, a month, or longer), etc. Thus, in some cases, a new geo-temporal trajectory may be established overnight for one user and over one week for another user. Similarly, a new geo-temporal trajectory may be established for a first user when the first user leaves a city border, but may be established for a second user when the second user leaves a county border. However, once established, a geo-temporal trajectory is treated as described herein.

At step 402, a first data structure is formed by sub-dividing the geo-temporal trajectory into segments. Each of the segment may be subsets of the transactions along the geo-temporal trajectory. Sub-dividing may be performed with respect to the feature described above with respect to FIG. 3.

In summary, sub-dividing the geo-temporal trajectory may be accomplished by defining a radius in space in which all transactions that take place within the radius are deemed to be within a single segment. For example, a radius may be 1000 meters in physical space, or 10 meters in physical space, or some other distance. All transactions that take place within that defined radius are defined to be within a single segment.

Optionally, a density of transactions within the radius may be determined. The density of transactions reflects how tightly the transactions are organized within a segment. For example, if a user went to a shopping mall, then the user would be expected to generate several transactions that are close to each other in physical space.

The one or more embodiments may take the density of transactions into account. For example, responsive to the density of transactions exceeding a threshold value, the radius may be adjusted. For example, assume that a gas station is within 1000 meters of a shopping mall. A dense set of transactions within 1000 meters suggest that the user was shopping within a shopping mall. However, an outlier transaction within the radius would suggest a single transaction at the gas station. Thus, the radius may be adjusted to, say, 500 meters, so that the transactions within the shopping mall are in one segment and the transaction at the gas station is in another segment.

In a specific example, additional details regarding sub-dividing (or segmentation) of the geo-temporal trajectory may be as follows. First, a segmentation of a sampled trajectory {(tᵢ,pᵢ)}i₁ⁿ (equation 2) may be a list of cutoff indices defined by equation 3:

1=cₒ<c₁<cₖ=p (3).

The i^{th} segment is then a subset of the sampled trajectory: {(tᵢ,pᵢ)}i_{c}_{ᵢ}₋₁^{c}^{ᵢ}. In other words, each segment may be characterized, itself, as a sampled trajectory or a sub-division of the trajectory, T.

FIG. 4B shows a sample algorithm (450) for subdividing a trajectory, or performing trajectory segmentation, at step (402). Further, FIG. 4B shows the inputs (452) to the algorithm and the outputs (454) from the algorithm. The algorithm in FIG. 4B is based on the observation that for many types of trajectories, intermittent periods of dense and sparse positions exist. Consider for instance the trajectory of a person throughout a day. Dense local segments correspond to time spent at and around the home, workplace, shopping mall, etc. (sometimes called a stay point), whereas between these segments a long and sparsely distributed locomotive activity may be expected.

The spread of points during a period of local activity has more than one source. When measuring the position of a completely static entity, measurement noise will cause the locations to be presented as a cloud around the actual location. While this fact, itself, can be overcome by averaging (neglecting adverse boundary effects depending on the length of the filter), for a locally moving entity, the measured spread of points will be a sum of the actual movement and the noise. Furthermore, when operating on a stream, it is not clear how to average local periods while leaving locomotive periods intact.

The segmentation approach allows differential consideration of local (or static) versus locomotion parts of a trajectory. The algorithm in FIG. 4B will average a full local segment, reducing it to a single centroid, while maintaining much of the structure of the other parts of the trajectory (up to a pre-defined radius).

When constructing the algorithm, the following considerations may be used:

1) The segmentation works on a trajectory stream (i.e. O(n) and finite memory)

2) For a given trajectory, the segmentation should be invariant to sampling density. For instance, for a trajectory derived from a drive from home to work, whether it is a fast drive, or a constant traffic jam (corresponding to dense or sparse sampling in space, assuming a constant sampling rate in time), the size of the resulting segmentation should be the same.

3) Dense regions corresponding to local activity (e.g., a shopping area for people), should be placed in a single segment irrespective of time or area.

In order to satisfy the first consideration, the algorithm in FIG. 4B proceeds in one pass over each trajectory. The number of points, and the radius and density of the current segment are constantly maintained.

The second consideration is satisfied by starting a new segment only after a pre-defined radius is passed (i.e. there is a minimum radius for a segment). As a result, denser sampling will have no effect on the segments produced.

The third consideration is satisfied by letting a segment grow past the pre-defined radius as long as the density in the segment is large enough.

The output of algorithm in FIG. 4B is both the segmentation and the centroids of each of the segments. Recall a segmentation (equation 3) is a list of the cutoff indexes, and thus does not serve in itself as a (standalone) condensed representation of the trajectory. The segment centroids, however, may serve as such a representation. Note that by adding a time-stamp to the centroids, the centroids become themselves a sampled trajectory. The time-stamp will, in practice, be either the mean time of the points in the segment, or the time of the beginning of the segment.

Note that the above description is one possible method for performing segmentation of a trajectory. The one or more embodiments contemplate different techniques for performing segmentation of a trajectory, such as by segmenting the trajectory only according to time or only according to space. Thus, the one or more embodiments are not limited to the technique given above.

Returning to FIG. 4A, at step 404, after subdividing the geo-temporal trajectory, a corresponding labeled dataset of transactions within the transactions is gathered for a subset of the segments. Gathering produces the second data structure. Gathering may be accomplished by collecting those transactions within the trajectory for which labels have already been provided.

At step 406, the second data structure is applied, as input to a machine learning classifier. Thus, this point in the method, the machine learning classifier has the information useful for inferring the disambiguated labels for non-labeled transactions. The second data structure may be applied as input by forming the second data structure as a vector in a form which the machine learning classifier is programmed to accept.

At step 408, an assignment of disambiguated labels applicable to the transactions is received from the machine learning classifier. The assignment may be received in the form of an output vector supplied by the machine learning classifier.

At this point, the method could terminate. However, the method may also take into account actions performed by a financial management application.

Attention is now turned to additional details regarding the machine learning now classifier. As one example among many, the machine learning classifier may be a recurrent neural network (RNN). RNNs include a family of methods that use neural networks to process sequential information. Processing of information by an RNN may be performed by keeping an internal state that is updated when presented with a new input in the sequence based on a computation that involves the previous state and the new input. Each element in the sequence may also be associated with an option from the RNN. In many cases, only the final output is considered as “the output” of the RNN on the sequence.

The one or more embodiments utilizes an RNN method to process the sequence of transactions and output a categorical label. For this purpose, a sequence may be used, with the following input values at each element of the sequence:

1) Locations for points on the geo-temporal trajectory may be included in the input vector. Again, the locations may include latitude, longitude, and global positioning coordinates. The data structure specifying the locations may be normalized on a grid such that the first location is (0,0). The data for locations may be made uniform in structure in order to make processing uniform, no matter where a transaction happened geographically.

2) Merchant identity for each transaction on the geo-temporal trajectory may be included in the input vector. Merchant identify may be performed via an embedding lookup. For example, from the information in the transaction, a lookup program used together with the RNN classifier, may look up additional information about the merchant identify and populate the input vector with the additional information.

3) Transaction amounts may be included in the input vector.

Other inputs may be included. For example, the following additional information may be included as inputs to the RNN, or included in the input vector to the RNN:

4) A description string about a transaction.

5) A location type code (city, country, etc.).

The information may be processed into a data structure which is designed for use with the RNN classifier. For example, the information may be processed such that a single element of a sequence is concatenated to a single vector that fed as input to the RNN.

The type of RNN used (e.g. long short term memory (LSTM)) is a parameter of the selected RNN method, as are the number of layers used, and representation size. The specific type of RNN used and the parameters of the RNN depend on the input described above.

The model described above is trained using supervised learning, based on the set of trajectories for which the associated labels are already done. Training may be performed using a gradient-based update rule, which is applied repeatedly until convergence (i.e., the “back-propagation” training method).

Thus, at step 410, a determination may be made whether to apply the disambiguated labels to a financial management application. If not, then the disambiguated labels are effectively stored at step 408, and the method may terminate. Otherwise, (a “yes” determination at step 410), at step 412, the financial management application may automatically store the disambiguated labels with the transactions. The action of storing the disambiguated labels by the financial management application effectively applies the disambiguated labels to the transactions in question. The method of FIG. 4A may terminate thereafter.

The method of FIG. 4A may be varied by having more, fewer, or revised steps. For example, the method of FIG. 4A may include training the machine learning classifier prior to step 406 (applying the second data structure to the machine learning classifier). The machine learning classifier may be trained by applying a training dataset to the machine learning classifier and then executing the machine learning classifier using the training dataset. The training dataset includes pre-labeled prior transactions.

The method of FIG. 4A may also include receiving such prior labels from the user. The method of FIG. 4A may also include associating the prior labels to the prior transactions to form the pre-labeled prior transactions.

The method of FIG. 4A may also be applied on an ongoing basis. For example, when a new transaction is received, a determination may be made in which segment of the established segments the new transaction belongs. In this case, the new transaction and a segment identifier for the new segment may be input into the machine learning classifier. The machine learning classifier may then output a new label for the new transaction.

While the various steps in flowchart of FIG. 4A are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that condition exists in accordance with one or more embodiments of the invention. As another example, determination steps may be performed by performing a test, such as checking a data value to test whether the value is consistent with the tested condition in accordance with one or more embodiments of the invention.

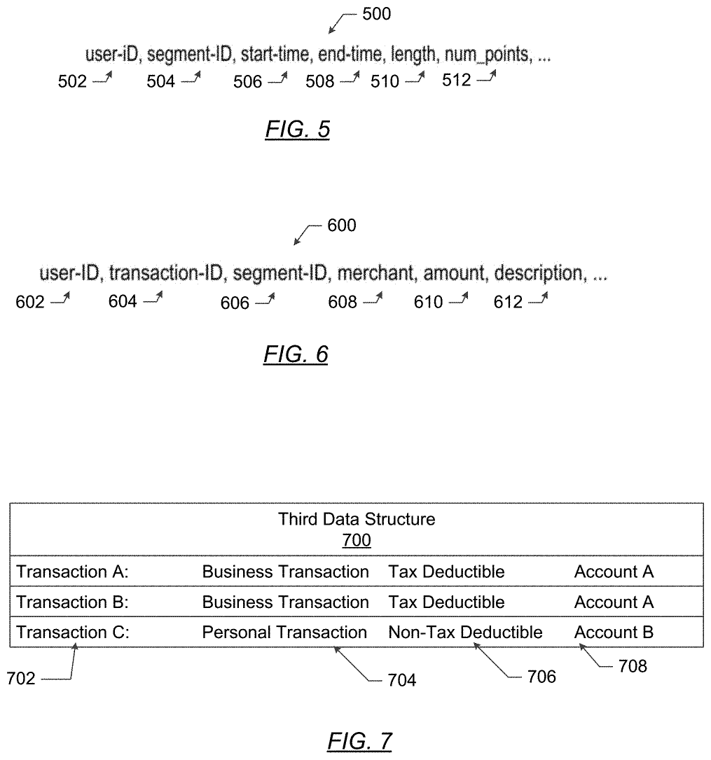

FIG. 5, FIG. 6, and FIG. 7 illustrate examples of data structures, in accordance with one or more embodiments. The data structures shown in FIG. 5 through FIG. 7 may be used with respect to the systems shown in FIG. 2 and FIG. 3, and in the method described with respect to FIG. 4A.

FIG. 5 is an example of a first data structure, such as first data structure (308) of FIG. 3. Data structure (500) may take the form of a vector, as shown in FIG. 5. However, the data structure (500) may take the form of a larger dimensional table, such as a two or higher dimensional table of data. The data structure (500) has a format which is particularly useful for use by a machine learning classifier. Thus, the structure of data structure (500) itself may be used to improve the operation of the machine learning classifier by providing the data in a format which the machine learning classifier can use efficiently.

In the example of FIG. 5, the data structure (500) may include a user identifier (502). The user identifier (502) identifies the user being tracked. The data structure (500) may also include a segment identifier (504), which identifies the segment to which a transaction is to be assigned. The data structure (500) may also include a start time (506), which identifies the starting time when a transaction occurs. The data structure (500) may also include an end time (508), which identifies the ending time when a transaction occurs. The data structure (500) may also include a length (510), which indicates a length or radius of the segment. The data structure (500) may also include a number of points (512), which indicates the number of points in the segment. Other information may also be included in the data structure (500).

In turn, FIG. 6 shows an example of a second data structure, such as second data structure (320) shown in FIG. 3. Data structure (600) shares some common properties with the data structure (500) of FIG. 5. However, the two data structures are different and are arranged separately and are later effectively combined when applied to the machine learning classifier.

Data structure (600) also may take the form of a vector, as shown in FIG. 6. The data structure (600) may also take the form of a larger dimensional table, such as a two or higher dimensional table of data. The data structure (600) has a format which is particularly useful for use by a machine learning classifier. Thus, the structure of data structure (600) itself may be used to improve the operation of the machine learning classifier by providing the data in a format which the machine learning classifier can use efficiently.

In the example of FIG. 6, the data structure (600) may include a user identifier (602). The user identifier (602) identifies the user being tracked and may be user identifier (502) of FIG. 5. The data structure (600) may also include a transaction identifier (604), which identifies a particular transaction. The data structure (600) may also include a segment identifier (606). The segment identifier (606) identifies the segment to which the transaction is to be assigned and may be the segment identifier (504) of FIG. 5. The data structure (600) may also include a merchant (608), which identifies the merchant from which the user purchased a good or service. The data structure (600) may also include an amount (610), which indicates the dollar value of the transaction.

The data structure (600) may also include a description (612). The description (612) may be a text description which describes the nature of the transaction. The description (612) could be a pre-designated label. The description (612) could be a number which represents information about the transaction or is a representation of a pre-designated label. The description (612) could also be, in some embodiments, other information relating to the transaction.

Attention is now turned to FIG. 7. Third data structure (700) is an example of a third data structure that results when disambiguated labels are applied to individual transactions. Thus, the third data structure (700) may be an example of an output of the modified machine learning classifier (200) in FIG. 2 or the output of the machine learning classifier (340) in FIG. 3. However, the third data structure (700) may also be the result of a financial management application applying predicted labels to transactions already recorded in the financial management application.

The third data structure (700) may be a table data structure where rows represent transaction identifiers, such as Transaction C (702). Columns in the third data structure (700) represent various information about the transactions. For example, a disambiguated label may include “personal transaction” (704). In this example, without disambiguation, the “personal transaction” (704) could have been labeled as a “business transaction” when considering only the information contained in the original Transaction C (702) by itself.

Additional labels may also be applied, as a result of applying the disambiguated label of “personal transaction” (704). For example, the impact of the “personal transaction” (704) disambiguated label may be that Transaction C (702) is not tax-deductible. Thus, “non-tax deductible” (706) may be an additional label that is automatically applied using rules after the machine learning classifier has applied the disambiguated label of “personal transaction” (704).

Similarly, a financial management application could treat the Transaction C (702) differently based on the disambiguated label of “personal transaction” (704). For example, a label of “Account B” (708) could be applied to the Transaction C (702) using rules after the machine learning classifier has applied the disambiguated label of “personal transaction” (704). In this case, the financial management application may apply transactions with different labels to different accounts, “Account B” (708) in this instance. Business transactions, however, could be automatically applied to different, business accounts.

Thus, the third data structure (700) may be tailored for use by a financial management application based on the disambiguated label applied using the method shown in FIG. 4. Accordingly, the third data structure (700) can improve the operation or capabilities of the financial management application.

FIG. 8 illustrates a specific example of automatic dis-ambiguous labeling of transactions, in accordance with one or more embodiments. The example shown in FIG. 8 may be implemented using the system of FIG. 2 or the system of FIG. 3 using the method of FIG. 4. Thus, as used with respect to FIG. 8, the term “system” may refer to either of the systems in FIG. 2 or FIG. 3. The example of FIG. 8 relates to transactions performed by a user, John Doe.

In the example shown, in the course of a day, Jon Doe visits four merchants and generates one transaction at each merchant. As a result, a list of transactions (800) is created.

In particular, John Doe makes purchase at Widget Stop (Transaction A), which is a location X1, Y1, at time T1. John Doe has already indicated that the transaction at Widget Stop is a business expense, and hence has applied the “business” label.

John Doe also makes a purchase (Transaction B) at Coffee Shop, which is at location X2, Y2, at time T2. John Doe has already indicated that the transaction at Coffee Shop is a personal expense, and hence has applied the “personal” label.

John Doe also makes a purchase (Transaction C) at Building Biz, at location X3, Y3, at time T3. However, the transaction information from the transaction at Building Biz does not indicate that the transaction should be “personal” or “business.” Thus, the label for Transaction C is ambiguous.

John Doe also makes a purchase (Transaction D) at Food Mart, at location X4, Y4, at time T4. However, the transaction information from the transaction at Food Mart does not indicate that the transaction should be “personal” or “business.” Thus, the label for Transaction D is ambiguous. Assume that John Doe generates many other transactions throughout the day, but for clarity the additional transactions are not shown in the list of transactions (800) shown in FIG. 8.

In this example, the system generates a trajectory (802) for John Doe's travels throughout the day, using the location information and the time information present in the transactions themselves, including the locations and time information in the list of transactions (800). While the trajectory (802) is shown as a series of points connected by lines, the trajectory (802) may also be represented by a vector, as described above with respect to FIG. 4. In this example, the four transactions in list of transactions (800) are part of the four clusters of transactions shown in FIG. 8. For example, transaction cluster (804) may include Transaction B from the list of transactions (800).

Next, the system segments the trajectory (802), as described with respect to FIG. 3 and FIG. 4. The result of segmentation is the segmented trajectory (806). The segmented trajectory (806) includes a number of circles, which represent individual segments. The central dot within a circle represents a location. The radius of the circle is the radial distance defined for a given segment, as described above. Thus, for example, all transactions within segment (808), which include Transaction B from list of transactions (800), are contained within the radius shown. As with the trajectory (802), the segmented trajectory (806) may also be represented as a vector.

Thus, the trajectory (802) and the segmented trajectory (806) may be provided to the RNN deep learning classifier (810) in the form of input vectors. The term “RNN” means “recurring neural network.” The RNN deep learning classifier (810) is a type of machine learning classifier, as described above with respect to FIG. 3 and FIG. 4. The RNN deep learning classifier (810) was previously trained using pre-labeled data, such as the labels applied to Transaction A and Transaction B in the list of transactions (800). Thus, the RNN deep learning classifier (810) is programmed to find inferences and relationships among the data. The RNN predicts or classifies which of the ambiguous labels could be applied to ambiguous transactions, such as Transaction C and Transaction D in the list of transactions (800).

In this example, the output of the RNN deep learning classifier (810) is third data structure (812). The third data structure (812) includes the information shown in the list of transactions (800), but also disambiguates the labels for Transaction C and Transaction D. In particular, the RNN deep learning classifier (810) has predicted that the Transaction C is a “personal” expense and the Transaction D is a “business” expense. Later, optionally, John Doe may verify that these expenses were, indeed, correctly labeled.

Note that the disambiguated labels are not necessarily obvious. For example, one might expect a Food Mart transaction to be a personal expense and a Building Biz transaction to be a business expense, because the Widget Stop (more related to buildings) and Coffee Shop (more related to food) transactions were labeled as “business” and “personal,” respectively. However, the information contained in the trajectory allows the RNN deep learning classifier (810) to infer what would otherwise be hidden relationships in the underlying data that allow the RNN deep learning classifier (810) to correctly predict the correct labels for the corresponding transactions.

Note that the third data structure (812) may take different forms. For example, the third data structure (812) could be only the predicted labels. Thus, the output could be a series of numbers in a one dimensional array, with each number corresponding to a separate label. The labels could then be stored, or perhaps used by another program, such as a financial management application (814).

Thus, optionally, the third data structure (812) may be provided to a financial management application (814). In the case that the third data structure (812) is only labels, the financial management application (814) may apply the labels to the transactions in order to disambiguate any ambiguous transactions. The financial management application (814) could also use the information in the disambiguated labels to perform other actions, such as to record particular transactions to different accounts, to prepare tax forms, etc.

Embodiments of the invention may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities that implement the features and elements of the disclosure.

The computer processor(s) (902) may be an integrated circuit for processing instructions. For example, the computer processor(s) (902) may be one or more cores or micro-cores of a processor. The computing system (900) may also include one or more input devices (910), such as a touchscreen, keyboard, mouse, microphone, touchpad, electronic pen, or any other type of input device.

The communication interface (908) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the computing system (900) may include one or more output devices (912), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (902), non-persistent storage device(s) (904), and persistent storage device(s) (906). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

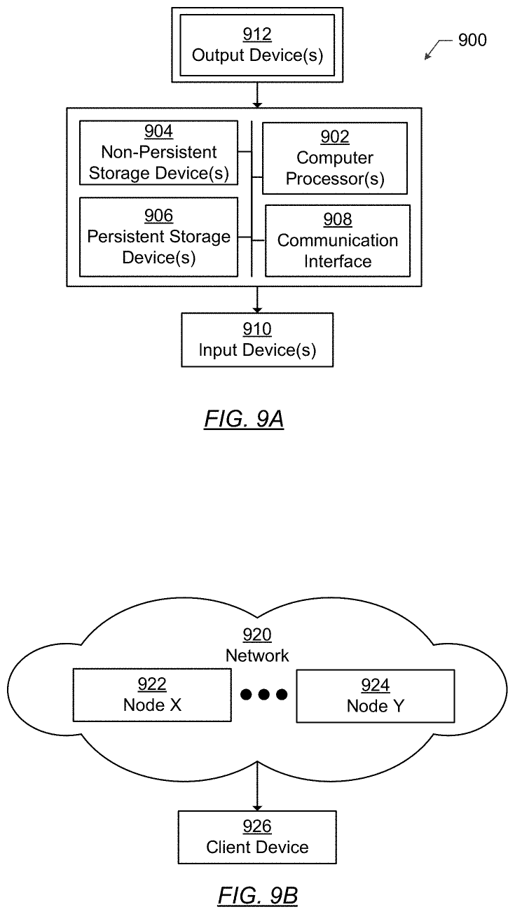

The computing system (900) in FIG. 9A may be connected to or be a part of a network. For example, as shown in FIG. 9B, the network (920) may include multiple nodes (e.g., node X (922), node Y (924)). Each node may correspond to a computing system, such as the computing system shown in FIG. 9A, or a group of nodes combined may correspond to the computing system shown in FIG. 9A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (900) may be located at a remote location and connected to the other elements over a network.

Although not shown in FIG. 9B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (922), node Y (924)) in the network (920) may be configured to provide services for a client device (926). For example, the nodes may be part of a cloud computing system. The nodes may include functionality to receive requests from the client device (926) and transmit responses to the client device (926). The client device (926) may be a computing system, such as the computing system shown in FIG. 9A. Further, the client device (926) may include and/or perform all or a portion of one or more embodiments of the invention.

The computing system or group of computing systems described in FIGS. 9A and 9B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 9A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 9A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 9A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 9A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 9A and the nodes and/or client device in FIG. 9B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
establishing, using a plurality of electronic transactions of a user, a geo-temporal trajectory of the user;
forming a first data structure by sub-dividing the geo-temporal trajectory into a plurality of segments comprising a plurality of subsets of the plurality of electronic transactions along the geo-temporal trajectory, wherein sub-dividing is performed with respect to a selected feature;
gathering, for a subset of the plurality of segments, a corresponding labeled dataset of transactions within the plurality of electronic transactions to generate a second data structure;
applying, as input, the second data structure to a machine learning classifier;
receiving, from the machine learning classifier, an assignment of a plurality of disambiguated labels to the plurality of electronic transactions; and
storing, automatically in a financial management application, the plurality of disambiguated labels as assigned to the plurality of electronic transactions.

2. The method of claim 1, further comprising:
training the machine learning classifier using a training dataset which includes a plurality of pre-labeled prior electronic transactions.

3. The method of claim 2, further comprising:
receiving, from the user, prior labels for prior electronic transactions; and
associating the prior labels to the prior electronic transactions to form the pre-labeled prior electronic transactions.

4. The method of claim 1, wherein:
each of the plurality of electronic transactions comprises a corresponding data structure,
each corresponding data structure comprises a plurality of data entries including a corresponding time of a corresponding transaction and a corresponding location of the corresponding transaction, and
each corresponding labeled dataset occurs within a particular segment of the plurality of segments.

5. The method of claim 1, wherein:
at least one of the plurality of electronic transactions is ambiguous,
ambiguous comprises the at least one the plurality of electronic transactions having multiple, mutually exclusive labels applicable to the at least one of the plurality of electronic transactions, and
storing disambiguates the at least one of the plurality of electronic transactions.

6. The method of claim 1, wherein the selected feature is selected from the group consisting of: time, space, and a combination of time and space.

7. The method of claim 1, wherein the machine learning classifier comprises a deep learning classifier.

8. The method of claim 1, wherein the machine learning classifier comprises a recurrent neural network.

9. The method of claim 1, further comprising:
receiving a new transaction;
determining in which segment of the plurality of segments the new transaction belongs;
inputting the new transaction and a segment identifier for the new segment into the machine learning classifier; and
receiving, as output of the machine learning classifier, a new label for the new transaction.

10. The method of claim 1, wherein sub-dividing the geo-temporal trajectory comprises:
defining a radius in space in which all transactions that take place within the radius are deemed to be within a single segment.

11. The method of claim 10, wherein sub-dividing the geo-temporal trajectory further comprises:
defining a density of transactions within the radius; and
responsive to the density of transactions exceeding a threshold value, adjusting the radius.

12. A system comprising:
a data repository storing:
a plurality of electronic transactions of a user,
a training dataset comprising pre-labeled prior electronic transactions,
a geo-temporal trajectory of the user,
a first data structure comprising the geo-temporal trajectory divided into a plurality of segments comprising a plurality of subsets of the plurality of electronic transactions along the geo-temporal trajectory, wherein the geo-temporal trajectory is divided with respect to a selected feature,
a second data structure comprising a labeled dataset of transactions within the plurality of transactions, the labeled dataset being for a subset of the plurality of segments, and
a plurality of disambiguated labels assigned to the plurality of electronic transactions;
a machine learning classifier, wherein the machine learning classifier is:
trained using the training dataset,
trained to determine how the geo-temporal trajectory influences labeling of the plurality of electronic transactions, and
trained to classify the plurality of electronic transactions by receiving, as input, the second data structure and by outputting the plurality of disambiguated labels applicable to the plurality of electronic transactions; and
a financial management application (FMA) programmed to:
manage finances of a user, and
apply the plurality of disambiguated labels to the plurality of electronic transactions to generate a third data structure.

13. The system of claim 12, wherein the machine learning classifier comprises a deep learning classifier.

14. The system of claim 12, wherein the machine learning classifier comprises a recurrent neural network.

15. The system of claim 12, wherein the first data structure comprises, for each electronic transaction in a particular segment, a user identifier, a segment identifier, a time, a position, and a number of transactions within a segment.

16. The system of claim 12, wherein the second data structure comprises, for each electronic transaction in a particular segment, a user identifier, a transaction identifier, a segment identifier, a merchant identifier, an amount of the electronic transaction, and a description of the electronic transaction.

17. The system of claim 12, wherein:
at least one of the plurality of electronic transactions is ambiguous,
ambiguous comprises the at least one the plurality of electronic transactions having multiple, mutually exclusive labels applicable to the at least one of the plurality of electronic transactions, and
labeling disambiguates the at least one of the plurality of electronic transactions.

18. A non-transitory computer readable storage medium storing program code which, when executed by a processor, performs a computer-implemented method comprising:
establishing, using a plurality of electronic transactions of a user, a geo-temporal trajectory of the user;
forming a first data structure by sub-dividing the geo-temporal trajectory into a plurality of segments comprising a plurality of subsets of the plurality of electronic transactions along the geo-temporal trajectory, wherein sub-dividing is performed with respect to a selected feature;
gathering, for a subset of the plurality of segments, a corresponding labeled dataset of transactions within the plurality of electronic transactions to generate a second data structure;
applying, as input, the second data structure to a machine learning classifier;
receiving, from the machine learning classifier, an assignment of a plurality of disambiguated labels to the plurality of electronic transactions; and
storing, automatically in a financial management application, the plurality of disambiguated labels as assigned to the plurality of electronic transactions.

19. The non-transitory computer readable storage medium of claim 18, wherein:
at least one of the plurality of electronic transactions is ambiguous,
ambiguous comprises the at least one the plurality of electronic transactions having multiple, mutually exclusive labels applicable to the at least one of the plurality of electronic transactions, and
storing disambiguates the at least one of the plurality of electronic transactions.

20. The non-transitory computer readable storage medium of claim 18, wherein the program code, when executed, causes the computer-implemented method to further comprise:
training the machine learning classifier using a training dataset which includes a plurality of pre-labeled prior electronic transactions.
